(19) United States
(12) Patent Application Publication
(10) Pub. No.: US 2013/0183229 A1
(43) Pub. Date: Jul. 18, 2013

(54) INTRODUCTION OF MESOPOROSITY INTO INORGANIC MATERIALS IN THE PRESENCE OF A NON-IONIC SURFACTANT

(71) Applicant: Rive Technology, Inc., Boston, MA (US)

(72) Inventor: Javier Garcia-Martinez, Alicante (ES)

(73) Assignee: RIVE TECHNOLOGY, INC., Boston, MA (US)

(21) Appl. No.: 13/741,079

(22) Filed: Jan. 14, 2013

Related U.S. Application Data
(60) Provisional application No. 61/586,476, filed on Jan. 13, 2012.

(51) Int. Cl. C01B 39/24; C01B 39/14; C01B 39/22

(52) U.S. Cl. CPC C01B 39/24; C01B 39/22; C01B 39/14
USPC 423/700

(57) ABSTRACT

Compositions and methods for introducing mesoporosity into inorganic materials in the presence of a non-ionic surfactant are disclosed herein. Mesopores can be introduced into inorganic materials, such as zeolites, by treating the inorganic materials with a non-ionic surfactant. The resulting mesoporous inorganic materials can have a total 20 to 135 Å diameter mesopore volume of at least 0.05 cc/g and a crystalline content of at least 20 weight percent as measured by X-ray diffraction.

### RELATED APPLICATIONS

This application claims priority benefit under 35 U.S.C. Section 119(e) to U.S. Provisional Patent Ser. No. 61/586,476, filed on Jan. 13, 2012, the entire disclosure of which is incorporated herein by reference.

### BACKGROUND

1. Field

One or more embodiments of the present invention relate to methods for introducing mesoporosity into inorganic materials.

2. Description of Related Art

U.S. Patent Application Publication No. 2007/0244347 describes a method for introducing mesoporosity into zeolites. Prior to treatment, these zeolites, such as ultrastable zeolite Y (“USY”) provided by Zeolyst International, have a high silicon-to-aluminum ratio (“Si/Al”) and low extra-framework content. As previously described, these zeolites can be treated in the presence of a pore forming agent (e.g., a surfactant) at a controlled pH under certain time and temperature conditions to introduce mesoporosity into the zeolites. Thereafter, the mesostructured material can be treated to remove the pore forming agent. Although advances have been made in the art of introducing mesoporosity into zeolites, improvements are still needed.

### SUMMARY

One embodiment of the present invention concerns a method of forming a material comprising a mesoporous inorganic material having long-range crystallinity. The method of this embodiment comprises contacting an initial inorganic material having long-range crystallinity with a non-ionic surfactant thereby forming the mesoporous inorganic material having long-range crystallinity. In this embodiment, the mesoporous inorganic material having long-range crystallinity has a total 20 to 135 Å diameter mesopore volume of at least 0.05 cc/g and a crystalline content of at least 20 weight percent as measured by X-ray diffraction (“XRD”).

Another embodiment of the present invention concerns a method of forming a material comprising a mesoporous zeolite. The method of this embodiment comprises contacting an initial zeolite with a non-ionic surfactant in a pH controlled medium, thereby forming the mesoporous zeolite. In this embodiment, the mesoporous zeolite has a total 20 to 135 Å diameter mesopore volume of at least 0.05 cc/g and the pH controlled medium has a pH in the range of from about 2 and about 6.

### BRIEF DESCRIPTION OF THE DRAWING FIGURES

Embodiments of the present invention are described herein with reference to the following drawing figure, wherein:

FIG. 1 is a N₂ isotherm at 77K of the NH₄Y zeolite prepared in Example 1, illustrating a zeolite having increased mesoporosity;

FIG. 2 is a N₂ isotherm at 77K of the zeolite prepared in Example 2, illustrating a zeolite having increased mesoporosity;

FIG. 3 is a high magnification transmission electron microscopy (“TEM”) micrograph of the zeolite in Example 2 before treatment;

FIG. 4 is a high magnification TEM micrograph of the zeolite in Example 2 after treatment;

FIG. 5 is a N₂ isotherm at 77K of the zeolites prepared in Example 3, illustrating zeolites having increased mesoporosity;

FIG. 6 is a N₂ isotherm at 77K of the zeolite prepared in Example 4, illustrating a zeolite having increased mesoporosity; and

FIG. 7 is a N₂ isotherm at 77K of the zeolites prepared in Example 5, illustrating zeolites having increased mesoporosity.

### DETAILED DESCRIPTION

Various embodiments of the present invention concern methods for preparing a material containing a mesoporous inorganic material having long-range crystallinity. In one or more embodiments, the mesoporous inorganic material can be prepared by contacting an initial inorganic material with a mesopore forming agent in conjunction with an acid. The resulting mesoporous inorganic material can then be subject to various post-treatment procedures and/or be employed in a variety of applications.

As noted above, an initial inorganic material can be employed in forming the mesoporous inorganic materials. In one or more embodiments, the initial inorganic material can be a non-mesostructured inorganic material. In other various embodiments, the initial inorganic material can be a non-mesoporous inorganic material. As used herein, the term “non-mesoporous” shall denote a composition having a total volume of less than 0.05 cc/g of 20 to 80 Å diameter mesopores. In certain embodiments, initial inorganic starting materials can have a total 20 to 80 Å diameter mesopore volume of less than 0.01 cc/g. Additionally, suitable initial inorganic materials can have a total 1 to 20 Å micropore volume of at least 0.3 cc/g.

In various embodiments, the initial inorganic material can have a 1-dimensional, 2-dimensional, or 3-dimensional pore structure. Additionally, the initial inorganic material can itself exhibit long-range crystallinity. Materials with long-range crystallinity include all solids with one or more phases having repeating structures, referred to as unit cells, that repeat in a space for at least 10 nm. A long-range crystalline inorganic material structure may have, for example, single crystallinity, mono crystallinity, or multi crystallinity. Furthermore, in various embodiments, the initial inorganic material can be fully crystalline. In another embodiment, the initial inorganic material can be a one-phase hybrid material.

Examples of inorganic materials suitable for use as the initial inorganic material include, but are not limited to, metal oxides, zeolites, zeotypes, aluminophosphates, silico-aluminophosphates, gallophosphates, zincophosphates, and titanophosphates. Combinations of two or more types of these inorganic materials can also be employed as the initial inorganic material. In addition, the inorganic material can be a zeolite-like material, which represents a growing family of inorganic and organic/inorganic molecular sieves.

In one or more embodiments, the initial inorganic material comprises a zeolite. Examples of zeolites suitable for use as the initial inorganic material include, but are not limited to, zeolite A, faujasites (i.e., zeolites X and Y; “FAU”), mordenite (“MOR”), CHA, ZSM-5 (“MFI”), ZSM-12, ZSM-22, beta zeolite, synthetic ferrierite (ZSM-35), synthetic mordenite, and mixtures of two or more thereof. Additionally, ultra-stable (e.g., zeolite USY) and/or acid forms of zeolites can also be employed. In various embodiments, the initial inorganic material can comprise faujasite, mordenite, ZSM-5, or mixtures of two or more thereof. In one embodiment, the initial inorganic material comprises faujasite. In certain embodiments, the zeolite can be a zeolite Y selected from the group consisting of USY, NH₄Y, NaY, a rare earth ion zeolite Y, or mixtures thereof. When a zeolite is employed as the initial inorganic material, the zeolite can have an average unit cell size of at least 24.40, at least 24.45, or at least 24.50 Å.

In various embodiments, the initial zeolite can have a low framework silicon-to-aluminum ratio (“Si/Al”). For example, the initial zeolite can have a framework Si/Al ratio of less than 30, less than 25, less than 20, less than 15, or less than 10. Additionally, the initial zeolite can have a framework Si/Al ratio in the range of from about 1 to about 30, in the range of from about 2 to about 25, or in the range of from 5 to 20. Note that, as used herein, the silicon-to-aluminum ratio refers to the elemental ratio (i.e., silicon atoms to aluminum atoms) of the zeolite; this is in contrast to another commonly used parameter, the silica-to-alumina ratio (i.e., SiO₂/Al₂O₃) of the zeolite. Generally, the Si/Al of a zeolite can be determined via bulk chemical analysis. This method, however, does not distinguish between framework aluminum atoms and extra-framework aluminum (“EFAL”) atoms in the zeolite. As will be understood by those of ordinary skill in the art, the framework Si/Al can be determined by a combination of methods, such as using both bulk chemical analysis and aluminum-27 nuclear magnetic resonance (“²⁷Al NMR”) and/or silicon-29 nuclear magnetic resonance (“²⁹Si NMR”). In one or more embodiments described herein, the framework Si/Al can be determined by known methods in the art. For example, a combination of bulk chemical analysis and ²⁷Al NMR can be employed for determining the framework Si/Al of the zeolite.

In one or more embodiments, the initial inorganic material can be present as a part of a composite shaped article comprising at least one inorganic material (e.g., a zeolite) and at least one non-zeolitic material. In certain embodiments, the inorganic material in the composite shaped article can be a zeolite. Furthermore, the inorganic material can comprise a zeolite selected from the group consisting of faujasite, mordenite, ZSM-5, CHA, or mixtures of two or more thereof. In various embodiments, the zeolite comprises faujasite. The composite shaped article can comprise the inorganic material (e.g., a zeolite) in an amount of at least 0.1 weight percent, at least 15 weight percent, or at least 30 weight percent based on the total weight of the composite shaped article. Furthermore, the composite shaped article can comprise the inorganic material (e.g., a zeolite) in an amount in the range of from about 0.1 to about 99 weight percent, in the range of from about 5 to about 95 weight percent, in the range of from about 15 to about 70 weight percent, or in the range of from 30 to 65 weight percent based on the total weight of the composite shaped article. The non-zeolitic material of the composites shaped article can include, for example, one or more binder material components.

In preparing the above-mentioned mesoporous materials, the initial inorganic material can first optionally be combined with water to form an initial slurry. The water useful in forming the initial slurry can be any type of water. In various embodiments, the water employed in forming the optional initial slurry can be deionized water. In one or more embodiments, the initial inorganic material can be present in the optional initial slurry in an amount in the range of from about 1 to about 50 weight percent, in the range of from about 5 to about 40 weight percent, in the range of from about 10 to about 30 weight percent, or in the range of from about 15 to about 25 weight percent. In certain embodiments, the optional initial slurry can comprise the initial inorganic material in an amount of about 20 weight percent.

In forming the mesoporous inorganic material, the initial inorganic material (optionally as part of an initial slurry) can be contacted with a mesopore forming agent, which thereby forms an initial treatment mixture comprising the initial inorganic material and the mesopore forming agent. Any now known or hereafter discovered mesopore forming agents may be employed in the various embodiments described herein. In one or more embodiments, the mesopore forming agent can include a surfactant. In certain embodiments, a cationic surfactant can be employed. In another embodiment, the surfactant employed can comprise one or more alkyltrimethyl ammonium salts and/or one or more dialkyldimethyl ammonium salts. In yet another embodiment, the surfactant can be selected from the group consisting of cetyltrimethyl ammonium bromide (“CTAB”), cetyltrimethyl ammonium chloride (“CTAC”), and mixtures thereof. Other suitable mesopore forming agents include, but are not limited to, non-ionic surfactants, polymers (e.g., block copolymers), and soft templates.

In one or more embodiments, the surfactant comprises a non-ionic surfactant. Examples of suitable commercially available non-ionic surfactants include, but are not limited to, Pluronic™ surfactants (e.g., Pluronic P123™), available from BASF. Though not wishing to be bound by theory, it is believed that the use of a non-ionic surfactant as the mesopore forming agent is possible because the silica in the inorganic material can have a low isoelectric point (e.g., at a pH of about 2). Thus, under low pH conditions, the electrical charge of the inorganic material can be neutral or near neutral. This permits a neutral surfactant to be employed at low pH levels. One possible advantage of non-ionic surfactants is that they can be generally cheaper and less toxic than other types of surfactants (e.g., cationic surfactants). In addition, though not wishing to be bound by theory, it is believed that non-ionic surfactants can be easier to extract from the mesoporous inorganic materials because these surfactants are only attracted to the inorganic materials through hydrogen bonding and not ionic interactions, which would be the case when using a cationic surfactant and a negatively charged zeolite (e.g., at a pH well above its isoelectric point).

In various embodiments, the pH of the resulting initial treatment mixture can optionally be adjusted. For example, the pH of the resulting initial treatment mixture can be adjusted to fall within the range of from about 4 to about 8, or in the range of from about 5 to about 7. Various pH adjusting agents (e.g., acids or bases) may be employed during this optional pH adjustment step. In certain embodiments, the pH of the initial treatment mixture can optionally be adjusted with an acid. Any known organic or inorganic acid can be employed for optionally adjusting the pH of the initial treatment mixture. Examples of acids suitable for use in adjusting the pH of the initial treatment mixture can include, but are not limited to, hydrochloric acid, nitric acid, sulfuric acid, formic acid, acetic acid, sulfonic acid, and oxalic acid.

Following formation of the initial treatment mixture, whose pH has optionally been adjusted, an acid can be introduced into the initial treatment mixture thereby forming a second treatment mixture comprising the acid, the mesopore forming agent, and the inorganic material. Treatment of the initial inorganic material in this treatment mixture with the mesopore forming agent and the acid can cause a plurality of mesopores to form in the inorganic material, thereby resulting in a mesoporous inorganic material (e.g., a mesoporous zeolite). Acids suitable for use can be any organic or inorganic (mineral) acids. In various embodiments, the acid employed in this step of the formation process can be a dealuminating acid. In further embodiments, the acid can also be a chelating agent. Specific examples of acids suitable for use include, but are not limited to, hydrochloric acid, sulfuric acid, nitric acid, acetic acid, sulfonic acid, oxalic acid, citric acid, ethylenediaminetetraacetic acid, tartaric acid, malic acid, glutaric acid, succinic acid, and mixtures of two or more thereof. In certain embodiments, the initial treatment mixture can be prepared and/or subsequent mesopore formation steps can be performed in the absence or substantial absence of hydrofluoric acid. As used herein, the term “substantial absence” means a concentration of less than 10 parts per million by weight “ppmw”).

In various embodiments, the amount of acid employed in the initial treatment mixture can be in the range of from about 1 to about 10 milliequivalents per gram of the above-described initial inorganic material, in the range of from about 2 to about 8 milliequivalents, or in the range of from about 3 to about 6 milliequivalents. Additionally, the acid can be added to the initial treatment mixture by any methods known or hereafter discovered in the art. In certain embodiments, the acid can be added to the initial treatment mixture over a period of time. For example, the acid can be added to the initial treatment mixture over a period of time in the range of from about 5 minutes to about 10 hours, in the range of from about 10 minutes to about 5 hours, or in the range of from about 30 minutes to about 2 hours. Furthermore, in various embodiments, the acid can be added drop-wise to the initial treatment mixture. In one or more embodiments, the resulting second treatment mixture can have a pH in the range of from about 2 to about 6, or in the range of from 3 to 4.

It should be noted that, in various embodiments, the order of addition of the acid and the mesopore forming agent can be reversed. In other words, in certain embodiments, the initial inorganic material can first be contacted with an acid followed by being contacted with a mesopore forming agent. In still other embodiments, the acid and mesopore forming agent can be combined prior to contact with the initial inorganic material, thereby providing simultaneous or substantially simultaneous contact with the initial inorganic material. In yet other embodiments, the initial inorganic material can first be contacted with an acid, followed by dispersion in deionized water; thereafter, the mesopore forming agent can be added to the mixture. Regardless of the order of addition, the above-described reagents, concentration ratios, and conditions may still be employed. Additionally, in various embodiments, the above-described processes can be performed in the absence or substantial absence of a base.

Irrespective of the formation procedure, the resulting second treatment mixture can be agitated for a period of time. Any methods of agitation known or hereafter discovered in the art can be employed. For example, stirring, shaking, rolling, and the like may be employed to agitate the resulting second treatment mixture. In one or more embodiments, the second treatment mixture can be agitated for a period of time ranging from about 1 minute to about 24 hours, from about 5 minutes to about 12 hours, from about 10 minutes to about 6 hours, or from about 30 minutes to about 2 hours. Furthermore, the second treatment mixture can be heated (in the presence or absence of agitation) for a period of time. For instance, the second treatment mixture can be heated at a temperature in the range of from about 30 to about 100° C., or in the range of from about 40 to about 80° C. for a period of time ranging from about 30 minutes to about one week, or in the range of from about an hour to about 2 days. Furthermore, any combination of room-temperature agitation and heated agitation can be employed.

Following treatment with the above-described acid and mesopore forming agent, at least a portion of the resulting mesoporous inorganic material can be recovered from the second treatment mixture. Recovery of the mesoporous inorganic material can be performed by any solid/liquid separation techniques known or hereafter discovered in the art. For instance, the second treatment mixture can be subjected to filtration. In various embodiments, the recovered mesoporous inorganic material can be washed (e.g., with deionized water) one or more times. Optionally, the mesoporous inorganic material can be filtered again after washing.

Once the mesoporous inorganic material has been recovered from the second treatment mixture, it can optionally be contacted with a base. Any base known or hereafter discovered can be employed in the various embodiments described herein for treating the recovered mesoporous inorganic material. In various embodiments, the base can be selected from the group consisting of NaOH, NH₄OH, KOH, Na₂CO₃, TMAOH, and mixtures thereof. In one or more embodiments, optional treatment of the mesoporous inorganic material with a base can be performed under elevated temperature conditions. As used herein, the term “elevated temperature” shall denote any temperature greater than room temperature. In certain embodiments, contacting the mesoporous inorganic material with a base can be performed at a temperature in the range of from about 30 to about 200° C., in the range of from about 50 to about 150° C., or at about 80° C. Additionally, the amount of base employed can be such that the base is present at a ratio with the initial quantity of the initial inorganic material (described above) in the range of from about 0.1 to about 20 mmol per gram of initial inorganic material, in the range of from about 0.1 to about 5 mmol per gram of initial inorganic material, or in the range of from about 0.9 to about 4 mmol per gram of initial inorganic material. Furthermore, optional treatment with the base can be performed over a period of time. For example, optional treatment of the mesoporous inorganic material with a base can be performed over a period of time in the range of from about 1 minute to about 2 days, in the range of from about 30 minutes to about 1 day, or in the range of from about 2 hours to about 12 hours.

Following optional treatment with a base, at least a portion of the mesoporous inorganic material can be separated from the basic treatment mixture. For example, the mesoporous inorganic material can be filtered, washed, and/or dried. In one or more embodiments, the inorganic material can be filtered via vacuum filtration and washed with water. Thereafter, the recovered mesoporous inorganic material can optionally be filtered again and optionally dried.

Following the filter, wash, and drying steps, whether from the above-described second treatment mixture or the optional basic treatment medium, the recovered inorganic material can be subjected to additional heat treatment or chemical extraction in order to remove or recover the remaining mesopore forming agent. In one or more embodiments, the remaining mesopore forming agent can be removed by subjecting the inorganic material to calcination in nitrogen at a temperature in the range of from about 500 to about 600° C., followed by calcination in air within the same temperature range. The mesopore forming agent removal technique can be selected based on, for example, the time needed to remove all of the mesopore forming agent from the mesoporous inorganic material. The total time period employed for heat treatment of the mesoporous inorganic material can be in the range of from about 30 minutes to about 24 hours, or in the range of from 1 to 12 hours.

As noted above, the mesopore forming agent can be a non-ionic surfactant. In various embodiments, when a non-ionic surfactant is employed as the mesopore forming agent, at least a portion of the non-ionic surfactant can be recovered from the mesoporous inorganic material for reuse. Thus, in such embodiments, at least a portion of the recovered non-ionic surfactant can be employed for contacting a second initial inorganic material having long-range crystallinity to thereby form additional mesoporous inorganic material having long-range crystallinity. The procedures outline above may be employed in forming this second mesoporous inorganic material.

In various embodiments, the resulting mesoporous inorganic material can be subjected to one or more post-formation treatments. Suitable post-formation treatments are described, for example, in U.S. Patent Application Publication No. 2007/0244347, which is incorporated herein by reference in its entirety. In certain embodiments, the mesoporous inorganic material can be subjected to one or more post-formation treatments selected from the group consisting of calcination, ion exchange, steaming, incorporation into an adsorbent, incorporation into a catalyst, re-alumination, silicon incorporation, incorporation into a membrane, and combinations of two or more thereof. Suitable ion exchange procedures for the resulting mesoporous inorganic material include, but are not limited to, ammonium ion exchange, rare earth ion exchange, lithium ion exchange, potassium ion exchange, calcium ion exchange, and combinations of two or more thereof.

The resulting mesoporous inorganic material can be a one-phase hybrid single crystal having long-range crystallinity, or be fully crystalline, and can include mesopore surfaces defining a plurality of mesopores. As used herein, the terms “long-range crystallinity” and “fully crystalline” are substantially synonymous, and are intended to denote solids with one or more phases having repeating structures, referred to as unit cells, that repeat in a space for at least 10 nm. Furthermore, a cross-sectional area of each of the plurality of mesopores can be substantially the same. Additionally, in one or more embodiments, the mesoporous inorganic material can be a mesostructured inorganic material.

In various embodiments, the mesoporous inorganic material can have a total 20 to 135 Å diameter mesopore volume of at least 0.05, 0.06, 0.07, 0.08, 0.09, 0.10, 0.11, 0.12, 0.13, 0.14, 0.15, 0.20, or 0.25 cc/g. Additionally, the mesoporous inorganic material can have a total 20 to 135 Å diameter mesopore volume in the range of from about 0.05 to about 0.70 cc/g, in the range of from about 0.10 to about 0.60 cc/g, in the range of from about 0.15 to about 0.50 cc/g, or in the range of from 0.20 to 0.40 cc/g.

In various embodiments, the mesoporous inorganic material can have a total 0 to 20 Å diameter micropore volume in the range of from about 0 to about 0.40 cc/g, in the range of from about 0.01 to about 0.35 cc/g, in the range of from about 0.02 to about 0.30 cc/g, or in the range of from about 0.03 to about 0.25 cc/g.

In various embodiments, the resulting mesoporous inorganic material can have a total 20 to 135 Å diameter mesopore volume that is at least 5, at least 10, at least 20, at least 30, at least 40, at least 50, at least 60, at least 70, at least 80, at least 90, at least 100, at least 200, at least 300, at least 400, or at least 500 percent greater than the 20 to 135 Å diameter mesopore volume of the above-described initial inorganic material. Furthermore, the mesoporous inorganic material can have a total 20 to 135 Å diameter mesopore volume that is at least 0.02, at least 0.04, at least 0.05, at least 0.06, at least 0.07, at least 0.08, at least 0.09, at least 0.1, at least 0.2, at least 0.3, at least 0.4, or at least 0.5 cc/g greater than the total 20 to 135 Å diameter mesopore volume of the initial inorganic material.

In various embodiments, when the initial inorganic material is a zeolite, the mesoporous zeolite can have a framework Si/Al of less than less than 30, less than 25, less than 20, less than 15, or less than 10. Additionally, the mesoporous zeolite can have a framework Si/Al ratio in the range of from about 1 to about 30, in the range of from about 2 to about 25, or in the range of from 5 to 20.

In one or more embodiments, the mesoporous inorganic material can have a crystalline content of at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent, as measured by X-ray diffraction (“XRD”).

### Applications

The unique structure of mesoporous inorganic materials having long-range crystallinity can be useful to a variety of fields, and should address certain limitations associated with conventional zeolites. As catalysis is an important field of application for zeolites, special emphasis is placed on the catalytic applications of mesoporous inorganic materials having long-range crystallinity.

The combination of a mesostructure, high surface-area, and controlled pore or interior thickness as measured between adjacent mesopores should provide for access to bulky molecules and reduce the intracrystalline diffusion barriers. Thus, enhanced catalytic activity for bulky molecules should be observed using mesoporous inorganic materials having long-range crystallinity, as compared to conventional zeolites. Catalytic cracking is selectivity and/or efficiency limited because diffusion is limited by the small pore size of the zeolite H—Y. Because the conventional unconverted zeolite crystal has limited diffusion, it is difficult for an initial reaction product (e.g., 1,3-diisopropyl benzene) to exit the zeolite. As a result, over cracking occurs and light compounds are formed resulting in excess formation of undesirable products, such as cumene, benzene, and coke. In contrast to catalytic cracking with the unmodified conventional zeolite H—Y, the larger pore size, the controlled mesopore volume, and the controlled interior or pore wall thickness present in the mesoporous inorganic material having long-range crystallinity facilitates the exit of desired products (i.e., 1,3-diisopropyl benzene) from the mesostructure, and over cracking that produces cumene, benzene, and coke is avoided. As a result, there is a higher conversion of the desired product, 1,3-diisopropyl benzene.

Acid catalysts with well-defined ultra-large pores are highly desirable for many applications, especially for catalytic cracking of the gas oil fraction of petroleum, whereby slight improvements in catalytic activity or selectivity would translate to significant economic benefits. More than 135 different zeolitic structures have been reported to date, but only about a dozen of them have commercial applications, mostly zeolites with 3-D (3-dimensional) pore structures. The incorporation of 3-D mesopores may be beneficial for zeolites with 1-D and 2-D pore structures as it would greatly facilitate intracrystalline diffusion. Zeolites with 1-D and 2-D pore structures are not widely used, because the pore structure is less then optimal.

Pyrolysis of plastics has gained renewed attention due to the possibility of converting these abundant waste products into valuable chemicals while also producing energy. Acidic catalysts, such as zeolites, have been shown to be able to reduce significantly the decomposition temperature of plastics and to control the range of products generated. However, the accessibility of the bulky molecules produced during plastic degradation has been severely limited by the micropores of zeolites. The use of mesoporous inorganic materials having long-range crystallinity can allow for reduced decomposition temperatures compared to unmodified commercial zeolites.

With their improved accessibility and diffusivity compared to conventional zeolites, mesoporous inorganic materials having long-range crystallinity may also be employed in place of unmodified conventional zeolites in other applications, such as, for example, gas and liquid-phase adsorption, separation, catalysis, catalytic cracking, catalytic hydrocracking, catalytic isomerization, catalytic hydrogenation, catalytic hydroformilation, catalytic alkylation, catalytic acylation, ion-exchange, water treatment, and pollution remediation. Many of these applications suffer currently from limitations associated with the small pores of zeolites, especially when bulky molecules are involved. Mesoporous inorganic materials having long-range crystallinity present attractive benefits over zeolites in such applications.

Organic dye and pollutant removal from water is of major environmental importance, and represents the third major use of zeolites (accounting for 80 tons of zeolites per year). However, most of the organic dyes are bulky, which make their removal slow or incomplete, requiring a huge excess of zeolites in the process. Mesoporous inorganic materials having long-range crystallinity offer significant advantage over unmodified conventional zeolites in organic dye and pollutant removal with their larger surface area and pore size.

### Application in Petrochemical Processing

The mesoporous inorganic materials having long-range crystallinity can have one or more of controlled pore volume, controlled pore size (e.g., cross sectional area and/or diameter), and controlled pore shape. Hydrocarbon reactions, including petrochemical processing, are mass-transfer limited. Accordingly, a mesoporous catalyst with controlled pore volume, pore size, and/or pore shape can facilitate transport of the reactants to and within active catalyst sites within the mesoporous catalyst and transport the products of the reaction out of the catalyst. Mesoporous inorganic materials having long-range crystallinity enable processing of very large or bulky molecules with dimensions of, for example, from about 2 to about 60 nm, from about 5 to about 50 nm, and from about 30 to about 60 nm.

Hydrocarbon and/or petrochemical feed materials that can be processed with the mesoporous inorganic materials having long-range crystallinity include, for example, a gas oil (e.g., light, medium, or heavy gas oil) with or without the addition of resids. The feed material can include thermal oils, residual oils, (e.g., atmospheric tower bottoms (“ATB”), heavy gas oil (“HGO”), vacuum gas oil (“VGO”), and vacuum tower bottoms (“VTB”), cycle stocks, whole top crudes, tar sand oils, shale oils, synthetic fuels (e.g., products of Fischer-Tropsch synthesis), heavy hydrocarbon fractions derived from the destructive hydrogenation of coal, tar, pitches, asphalts, heavy crude oils, sour crude oils, metal-laden crude oils, and waxy materials, including, but not limited to, waxes produced by Fischer-Tropsch synthesis of hydrocarbons from synthesis gas. Hydrotreated feedstocks derived from any of the above described feed materials may also be processed by using the mesoporous zeolitic materials.

Heavy hydrocarbon fractions from crude oil contain most of the sulfur in crude oils, mainly in the form of mercaptans, sulfides, disulfides, thiophenes, benzothiophenes, dibenzothiophenes, and benzonaphthothiophenes, many of which are large, bulky molecules. Similarly, heavy hydrocarbon fractions contain most of the nitrogen in crude oils, principally in the form of neutral N-compounds (e.g., indole and carbazole), basic N-compounds (e.g., pyridine, quinoline, acridine, and phenenthridine), and weakly basic N-compounds (e.g., hydroxipyridine and hydroxiquinoline) and their substituted H-, alkyl-, phenyl- and naphthyl-substituted derivatives, many of which are large, bulky materials. Sulfur and nitrogen species can be removed for production of clean fuels and resids or deeper cut gas oils with high metals content can also be processed using the mesoporous inorganic materials having long-range crystallinity described herein.

In various embodiments, the mesoporous inorganic materials having long-range crystallinity can be employed in chemical processing operations including, for example, catalytic cracking, fluidized catalytic cracking, hydrogenation, hydrosulfurization, hydrocracking, hydroisomerization, oligomerization, alkylation, or any of these in combination. Any of these chemical processing operations may be employed to produce, for example, a petrochemical product by reacting a petrochemical feed material with the mesoporous inorganic materials having long-range crystallinity described herein.

In various embodiments, the mesoporous inorganic material having long-range crystallinity can be used as an additive to other catalysts and/or other separation materials including, for example, a membrane, an adsorbent, a filter, an ion exchange column, an ion exchange membrane, or an ion exchange filter.

In various embodiments, the mesoporous inorganic material having long-range crystallinity can be used alone or in combination as an additive to a catalyst. The mesoporous inorganic material having long-range crystallinity can be added at from about 0.05 to about 100 weight percent to the catalyst. The additive may be employed in chemical processing operations including, for example, catalytic cracking, fluidized catalytic cracking, hydrogenation, hydrosulfurization, hydrocracking, hydroisomerization, oligomerization, alkylation, or any of these in combination. For example, the addition of small amounts of mesoporous inorganic materials having long-range crystallinity and/or crystalline nanostructured zeolites to conventional commercially available FCC catalysts allows for improvement in the catalytic performance.

Generally, FCC uses an FCC catalyst, which is typically a fine powder with a particle size of about 10 to 200 microns. The FCC catalyst can be suspended in the feed and propelled upward into a reaction zone. A relatively heavy hydrocarbon or petrochemical feedstock (e.g., a gas oil) can be mixed with the FCC catalyst to provide a fluidized suspension. The feedstock can be cracked in an elongated reactor, or riser, at elevated temperatures to provide a mixture of petrochemical products that are lighter hydrocarbon products than were provided in the feedstock. Gaseous reaction products and spent catalyst are discharged from the riser into a separator where they can be regenerated. Typical FCC conversion conditions employing FCC catalysts include a riser top temperature of about 500 to about 595° C., a catalyst/oil weight ratio of about 3 to about 12, and a catalyst residence time of about 0.5 to about 15 seconds. The higher activity of the mesoporous inorganic materials having long-range crystallinity can enable less severe processing conditions, such as, for example, lower temperature, lower catalyst to oil ratios, and/or lower contact time.

In various embodiments, a small amount of mesoporous inorganic material having long-range crystallinity blended with conventional FCC catalysts can enable pre-cracking of the bulkier molecules by the mesoporous inorganic material having long-range crystallinity contained in the blend. Conventional FCC catalysts have pore sizes too small to accommodate bulkier molecules. After the bulkier molecules have been pre-cracked they are processed in the small pores of the conventional FCC catalyst.

In various embodiments, mesoporous inorganic materials having long-range crystallinity can be blended with conventional catalysts. The additive mesoporous inorganic materials having long-range crystallinity can be incorporated into the conventional catalyst pellet. Shaped (e.g., pelletized) mesoporous materials can be mixed with the catalyst pellet. Alternatively, a conventional catalyst and the mesoporous inorganic materials having long-range crystallinity can be layered together. Any such mixture can be used in a refining application, for example, in fluidized catalytic cracking directly as is done with other additives. The amount of mesoporous inorganic material having long-range crystallinity added and the manner by which it is blended can be used to tune the yield and/or the structure of the products.

In one or more embodiments, the addition of or incorporation of mesoporous inorganic materials having long-range crystallinity to conventional commercially available Thermofor Catalytic Cracking (“TCC”) catalysts can provide an improvement in the catalytic performance. The TCC process is a moving bed process that uses pellet or bead shaped conventional catalysts having an average particle size of about one-sixty-fourth to one-fourth inch. Hot catalyst beads progress with a hydrocarbon or petrochemical feedstock downwardly through a cracking reaction zone. The hydrocarbon products are separated from the spent catalyst and recovered. The catalyst is recovered at the lower end of the zone and recycled (e.g., regenerated). Typically, TCC conversion conditions include an average reactor temperature from about 450 to about 510° C., a catalyst/oil volume ratio of from about 2 to about 7, and a reactor space velocity of from about 1 to about 2.5 vol/hr/vol. Mesoporous inorganic materials having long-range crystallinity can be substituted for TCC catalysts to improve the catalytic cracking of petrochemical or hydrocarbon feedstocks to petroleum product. Alternatively, the mesoporous inorganic materials having long-range crystallinity can be blended with the TCC catalyst.

In various embodiments, mesoporous inorganic materials having long-range crystallinity can be used as catalyst additives in any other catalytic application. For example, they may be used as additives in processes where bulky molecules must be processed.

In other various embodiments, mesoporous inorganic materials having long-range crystallinity can be used in hydrogenation. Conventional zeolites are good hydrogenation supports because they possess a level of acidity needed both for the hydrogenation of the aromatic compounds and for tolerance to poisons such as, for example, sulfur. However, the small pore size of conventional zeolites limit the size of the molecules that can be hydrogenated. Various metals, such as Pt, Pd, Ni, Co, Mo, or mixtures of such metals, can be supported on mesoporous inorganic materials having long-range crystallinity using surface modification methods, for example, ion exchange, described herein. The hydrogenation catalytic activity of mesoporous inorganic materials having long-range crystallinity modified to support various metals (e.g., doped with metals) shows a higher hydrogenation activity for bulky aromatic compounds as compared to other conventional materials, for example, metal supported on alumina, silica, metal oxides, MCM-41, and conventional zeolites. The mesoporous inorganic materials having long-range crystallinity modified to support various metals also show, compared to conventional materials, a higher tolerance to sulfur including, for example, sulfur added as thiophene and dibenzothiophene, which are common bulky components of crude oil that often end up in gas oil fractions.

In other various embodiments, mesoporous inorganic materials having long-range crystallinity can be used in hydrodesulfurization (“HDS”), including, for example, deep HDS and hydrodesulfurization of 4,6-dialkyldibenzothiophenes. Deep removal of sulfur species from gas oil has two main limitations: i) the very low reactivity of some sulfur species, for example, dimethyldibenzothiophenes, and ii) the presence of inhibitors in the feedstocks such as, for example, H₂S. Deep HDS is currently done with active metal sulfides on alumina, silica/alumina, and alumina/zeolite.

Generally, during HDS the feedstock is reacted with hydrogen in the presence of an HDS catalyst. Any oxygen, sulfur, and nitrogen present in the feed is reduced to low levels. Aromatics and olefins are also reduced. The HDS reaction conditions are selected to minimize cracking reactions, which reduce the yield of the most desulfided fuel product. Hydrotreating conditions typically include a reaction temperature from about 400 to about 900° F., a pressure between 500 to 5,000 psig, a feed rate (LHSV) of 0.5 hr⁻¹ to 20 hr⁻¹ (v/v), and overall hydrogen consumption of 300 to 2,000 scf per barrel of liquid hydrocarbon feed (53.4-356 m³ H₂/m³ feed).

Suitable active metal sulfides include, for example, Ni and Co/Mo sulfides. Zeolites provide strong acidity, which improves HDS of refractory sulfur species through methyl group migration. Zeolites also enhance the hydrogenation of neighboring aromatic rings. Zeolite acidity enhances the liberation of H₂S from the metal sulfide increasing the tolerance of the catalyst to inhibitors. However, bulky methylated polyaromatic sulfur species are not able to access the acidic sites of conventional zeolites. In contrast, the controlled mesoporosity and strong acidity of mesoporous inorganic materials having long-range crystallinity provide accessibility to the acidic sites and acidity that allows for the deeper HDS required for meeting future environmental restrictions.

In other various embodiments, mesoporous inorganic materials having long-range crystallinity can be used in hydrocracking. Metals, including noble metals such as, for example, Ni, Co, W, and Mo, and metal compounds are commercially used in hydrocracking reactions. These metals can be supported on mesoporous inorganic materials having long-range crystallinity using previously described methods. The mesoporous inorganic materials having long-range crystallinity including metals can be employed for hydrocracking of various feedstocks such as, for example, petrochemical and hydrocarbon feed materials.

Typically, hydrocracking involves passing a feedstock (i.e., a feed material), such as the heavy fraction, through one or more hydrocracking catalyst beds under conditions of elevated temperature and/or pressure. The plurality of catalyst beds may function to remove impurities such as any metals and other solids. The catalyst beads also crack or convert the longer chain molecules in the feedstock into smaller ones. Hydrocracking can be effected by contacting the particular fraction or combination of fractions with hydrogen in the presence of a suitable catalyst at conditions, including temperatures in the range of from about 600 to about 900° F. and at pressures from about 200 to about 4,000 psia, using space velocities based on the hydrocarbon feedstock of about 0.1 to 10 hr⁻¹.

As compared to conventional unmodified catalyst supports such as, for example, alumina, silica, and zeolites, the mesoporous inorganic materials having long-range crystallinity including metals allow for the hydrocracking of higher boiling point feed materials. The mesoporous inorganic materials having long-range crystallinity including metals produce a low concentration of heteroatoms and a low concentration of aromatic compounds. The mesoporous inorganic materials having long-range crystallinity including metals exhibit bifunctional activity. The metal, for example a noble metal, catalyzes the dissociative adsorption of hydrogen and the mesoporous inorganic material having long-range crystallinity provides the acidity.

The controlled pore size and controlled mesopore surface in the mesoporous inorganic materials having long-range crystallinity including metals can make the bifunctional activity more efficient compared to a bifunctional conventional catalyst. In addition to the zeolitic acidity present in the mesoporous inorganic materials having long-range crystallinity, the controlled pore size enables larger pores that allow for a high dispersion of the metal phase and the processing of large hydrocarbons.

In other embodiments, mesoporous inorganic materials having long-range crystallinity can be used in hydroisomerization. Various metals and mixtures of metals, including, for example, noble metals such as nickel or molybdenum and combinations thereof in, for example, their acidic form, can be supported on mesoporous inorganic materials having long-range crystallinity.

Typically, hydroisomerization is used to convert linear paraffins to branched paraffins in the presence of a catalyst in a hydrogen-rich atmosphere. Hydroisomerization catalysts useful for isomerization processes are generally bifunctional catalysts that include a dehydrogenation/hydrogenation component and an acidic component. Paraffins can be exposed to mesoporous inorganic materials having long-range crystallinity including metals and isomerized in a hydrogen flow at a temperature ranging from about 150 to about 350° C. to thereby produce branched hydrocarbons and high octane products. The mesoporous inorganic materials having long-range crystallinity including metals permit hydroisomerization of bulkier molecules than is possible with commercial conventional catalysts due, at least in part, to their controlled pore size and pore volume.

In other embodiments, mesoporous inorganic materials having long-range crystallinity can be used in the oligomerization of olefins. The controlled pore shape, pore size, and pore volume improves the selectivity properties of the mesoporous inorganic materials having long-range crystallinity. The selectivity properties, the increased surface area present in the mesopore surfaces, and the more open structure of the mesoporous inorganic materials having long-range crystallinity can be used to control the contact time of the reactants, reactions, and products inside the mesoporous inorganic materials having long-range crystallinity. The olefin can contact the mesoporous inorganic materials having long-range crystallinity at relatively low temperatures to produce mainly middle-distillate products via olefin-oligomerization reactions. By increasing the reaction temperature, gasoline can be produced as the primary fraction.

Where the mesoporous inorganic materials having long-range crystallinity are used in FCC processes, the yield of olefins production can be increased relative to FCC with conventional zeolites. The increased yield of olefins can be reacted by oligomerization in an olefin-to-gasoline- and/or -diesel process, such as, for example, MOGD (Mobile Olefins to Gas and Diesel, a process to convert olefins to gas and diesel). In addition, olefins of more complex structure can be oligomerized using the mesoporous inorganic materials having long-range crystallinity described herein.

The LPG fraction produced using mesoporous inorganic materials having long-range crystallinity has a higher concentration of olefins compared to other catalysts, including, for example, various conventional FCC catalysts, zeolites, metals oxides, and clays under catalytic cracking conditions both in fixed bed and fluidized bed reactor conditions. The mesopore size of the mesoporous inorganic materials having long-range crystallinity readily allows the cracked products to exit the mesoporous inorganic materials having long-range crystallinity. Accordingly, hydrogen transfer reactions are reduced and the undesired transformation of olefins to paraffins in the LPG fraction is reduced. In addition, over-cracking and coke formation are limited, which increases the average life time of the catalyst.

The controlled pore size, pore volume, and mesopore surfaces provide an open structure in the mesostructured zeolites. This open structure reduces the hydrogen transfer reactions in the gasoline fraction and limits the undesired transformation of olefins and naphthenes into paraffins and aromatics. As a result, the octane number (both RON and MON) of the gasoline produced using the mesoporous inorganic materials having long-range crystallinity is increased.

The acidity and the controlled mesoporosity present in the mesoporous inorganic materials having long-range crystallinity can enable their use in alkylation reactions. Specifically, olefins and paraffins react in the presence of the mesoporous inorganic materials having long-range crystallinity to produce highly branched octanes. The highly branched octane products readily exit the open structure of the mesoporous inorganic materials having long-range crystallinity, thereby minimizing unwanted olefin oligomerization.

In other embodiments, the mesoporous inorganic materials having long-range crystallinity can be used to process a petrochemical feed material to petrochemical product by employing any of a number of shape selective petrochemical and/or hydrocarbon conversion processes. In one embodiment, a petrochemical feed can be contacted with the mesoporous inorganic material having long-range crystallinity under reaction conditions suitable for dehydrogenating hydrocarbon compounds. Generally, such reaction conditions include, for example, a temperature of from about 300 to about 700° C., a pressure from about 0.1 to about 10 atm, and a WHSV from about 0.1 to about 20 hr⁻¹.

In other embodiments, a petrochemical feed can be contacted with the mesoporous inorganic materials having long-range crystallinity under reaction conditions suitable for converting paraffins to aromatics. Generally, such reaction conditions include, for example, a temperature of from about 300 to about 700° C., a pressure from about 0.1 to about 60 atm, a WHSV of from about 0.5 to about 400 hr⁻¹, and an H₂/HC mole ratio of from about 0 to about 20.

In other embodiments, a petrochemical feed can be contacted with the mesoporous inorganic materials having long-range crystallinity under reaction conditions suitable for converting olefins to aromatics. Generally, such reaction conditions include, for example, a temperature of from about 100 to about 700° C., a pressure from about 0.1 to about 60 atm, a WHSV of from about 0.5 to about 400 hr-1, and an H2/HC mole ratio from about 0 to about 20.

In other embodiments, a petrochemical feed can be contacted with the mesoporous inorganic materials having long-range crystallinity under reaction conditions suitable for isomerizing alkyl aromatic feedstock components. Generally, such reaction conditions include, for example, a temperature of from about 230 to about 510° C., a pressure from about 3 to about 35 atm, a WHSV of from about 0.1 to about 200 and an H₂/HC mole ratio of from about 0 to about 100.

In other embodiments, a petrochemical feed can be contacted with the mesoporous inorganic materials having long-range crystallinity under reactions conditions suitable for disproportionating alkyl aromatic components. Generally, such reaction conditions include, for example, a temperature ranging from about 200 to about 760° C., a pressure ranging from about 1 to about 60 atm, and a WHSV of from about 0.08 to about 20 hr⁻¹.

In other embodiments, a petrochemical feed can be contacted with the mesoporous inorganic materials having long-range crystallinity under reaction conditions suitable for alkylating aromatic hydrocarbons (e.g., benzene and alkylbenzenes) in the presence of an alkylating agent (e.g., olefins, formaldehyde, alkyl halides, and alcohols). Generally, such reaction conditions include a temperature of from about 250 to about 500° C., a pressure from about 1 to about 200 atm, a WHSV of from about 2 to about 2,000 hr⁻¹, and an aromatic hydrocarbon/alkylating agent mole ratio of from about 1/1 to about 20/1.

In other embodiments, a petrochemical feed can be contacted with the mesoporous inorganic materials having long-range crystallinity under reaction conditions suitable for transalkylating aromatic hydrocarbons in the presence of polyalkylaromatic hydrocarbons. Generally, such reaction conditions include, for example, a temperature of from about 340 to about 500° C., a pressure from about 1 to about 200 atm, a WHSV of from about 10 to about 1,000 hr⁻¹, and an aromatic hydrocarbon/polyalkylaromatic hydrocarbon mole ratio of from about 1/1 to about 16/1.

Generally, suitable conditions for a petrochemical or hydrocarbon feed to contact the mesoporous inorganic materials having long-range crystallinity include temperatures ranging from about 100 to about 760° C., pressures ranging from above 0 to about 3,000 psig, a WHSV of from about 0.08 to about 2,000 hr⁻¹, and a hydrocarbon compound mole ratio of from 0 to about 100.

### Application in Compound Removal

The microporosity, mesoporosity, and ion exchange properties present in the mesoporous inorganic materials having long-range crystallinity can enable removal of inorganic and organic compounds from solutions. Suitable solutions can be aqueous or organic solutions. Accordingly, the mesoporous inorganic materials having long-range crystallinity can be employed in water treatment, water purification, pollutant removal, and/or solvent drying. Other configurations such as fixed bed, filters, and membranes can be also used in addition to the mesoporous inorganic materials having long-range crystallinity. Optionally, mesoporous inorganic materials having long-range crystallinity can be employed as additives with conventional separation means including, for example, fixed bed, filters, and membranes. The mesoporous inorganic materials having long-range crystallinity can also be substituted for other separation means in, for example, fixed bed, filters, and membranes. The mesoporous inorganic materials having long-range crystallinity can be recycled by ion exchange, drying, calcinations or other conventional techniques and reused.

### Application in Adsorption

The mesoporous inorganic materials having long-range crystallinity can be used to adsorb gaseous compounds including, for example, volatile organic compounds (“VOCs”), which are too bulky to be adsorbed by conventional unmodified zeolites. Accordingly, pollutants that are too bulky to be removed by conventional unmodified zeolites can be removed from a gaseous phase by direct adsorption. Mesoporous inorganic materials having long-range crystallinity can be employed for adsorption in various adsorption configurations such as, for example, membranes, filters, and fixed beds. Adsorbed organic compounds can be desorbed from the mesoporous inorganic materials having long-range crystallinity by heat treatment. Thus, the mesoporous inorganic materials having long-range crystallinity can be recycled and then reused.

### Application in Gas Separation

Mesoporous inorganic materials having long-range crystallinity can be grown on various supports by employed techniques such as, for example, seeding, hydrothermal treatment, dip coating, and/or use of organic compounds. They can be physically mixed with conventional zeolites or metal oxides. Continuous layers of mesoporous inorganic materials having long-range crystallinity can be used as membranes and/or catalytic membranes on, for example, porous supports. Mesoporous inorganic materials having long-range crystallinity are unique molecular sieves containing both microporosity and mesoporosity. They may be employed in various configurations including, for example, membranes for separation of gases based on physicochemical properties such as, for example, size, shape, chemical affinity, and physical properties.

### Application in Fine Chemicals and Pharmaceuticals

A mesoporous inorganic material having long-range crystallinity has increased active site accessibility as compared to the same zeolite in conventional form. Accordingly, the activity of some important chemical reactions used in fine chemical and pharmaceutical production can be improved by substituting a conventional zeolite used in the process for a mesoporous inorganic material having long-range crystallinity. In addition, a mesoporous inorganic material having long-range crystallinity may be employed as an additive to a catalyst typically employed in such fine chemical and pharmaceutical production reactions. Suitable processes that can be improved by using a mesoporous inorganic material having long-range crystallinity include, for example, isomerization of olefins, isomerization of functionalized saturated systems, ring enlargement reactions, Beckman rearrangements, isomerization of arenes, alkylation of aromatic compounds, acylation of arenes, ethers, and aromatics, nitration and halogenation of aromatics, hydroxyalylation of arenes, carbocyclic ring formation (including Diels-Alder cycloadditions), ring closure towards heterocyclic compounds, amination reactions (including amination of alcohols and olefins), nucleophilic addition to epoxides, addition to oxygen-compounds to olefins, esterification, acetalization, addition of heteroatom compounds to olefins, oxidation/reduction reactions such as, but not limited to, Meerwein-Ponndorf-Verley reduction and Oppenauer oxidation, dehydration reactions, condensation reactions, C—C formation reactions, hydroformylation, acetilization, and amidation.

### Application in Slow Release Systems

Chemicals and/or materials having useful properties such as, for example, drugs, pharmaceuticals, fine chemicals, optic, conducting, semiconducting magnetic materials, nanoparticles, or combinations thereof, can be introduced to mesoporous inorganic materials having long-range crystallinity using one or more modifying methods. For example, chemicals and/or materials may be incorporated into the mesoporous inorganic materials having long-range crystallinity by, for example, adsorption or ion exchange. In addition, such useful chemicals can be combined with the mesoporous inorganic materials having long-range crystallinity by creating a physical mixture, a chemical reaction, heat treatment, irradiation, ultrasonication, or any combination thereof.

The release of the chemicals and/or materials having useful properties can be controlled. Controlled release may take place in various systems such as, for example, chemical reactions, living organisms, blood, soil, water, and air. The controlled release can be accomplished by physical reactions or by chemical reactions. For example, controlled release can be accomplished by chemical reactions, pH variation, concentration gradients, osmosis, heat treatment, irradiation, and/or magnetic fields.

### Kits

One or more embodiments also provide kits for conveniently and effectively implementing various methods described herein. Such kits can comprise any of the mesoporous inorganic materials having long-range crystallinity described herein, and a means for facilitating their use consistent with various methods. Such kits may provide a convenient and effective means for assuring that the methods are practiced in an effective manner. The compliance means of such kits may include any means that facilitate practicing one or more methods associated with the inorganic materials described herein. Such compliance means may include instructions, packaging, dispensing means, or combinations thereof. Kit components may be packaged for either manual or partially or wholly automated practice of the foregoing methods. In other embodiments involving kits, a kit is contemplated that includes block copolymers, and optionally instructions for their use.

### EXAMPLES

The following examples are intended to be illustrative of the present invention in order to teach one of ordinary skill in the art to make and use the invention and are not intended to limit the scope of the invention in any way.

### Example 1

### Introduction of Mesoporosity in NH₄Y Zeolite with Non-Ionic Surfactant

A mesoporous zeolite was prepared according to the following procedure. One gram of NH₄Y zeolite (CBV300; Zeolyst Int'l, Valley Forge, Pa.) was acid washed for 1 hour with 8.3 mL of a 4.5 meq citric acid solution. Thereafter, 21.7 mL of deionized (“DI”) water was added, followed by addition of 0.5 g of Pluronic P-123™ (BASF Corp.). The resulting mixture was stirred for 2 hours at room temperature, followed by stirring for 24 hours at 40° C. Finally, the mixture was treated at 80° C. for 48 hours. The solid was recovered by filtration and washed. The solid product was then heat treated to remove surfactant in N₂ for 2 hours at 550° C. and then for 4 hours in air at the same temperature.

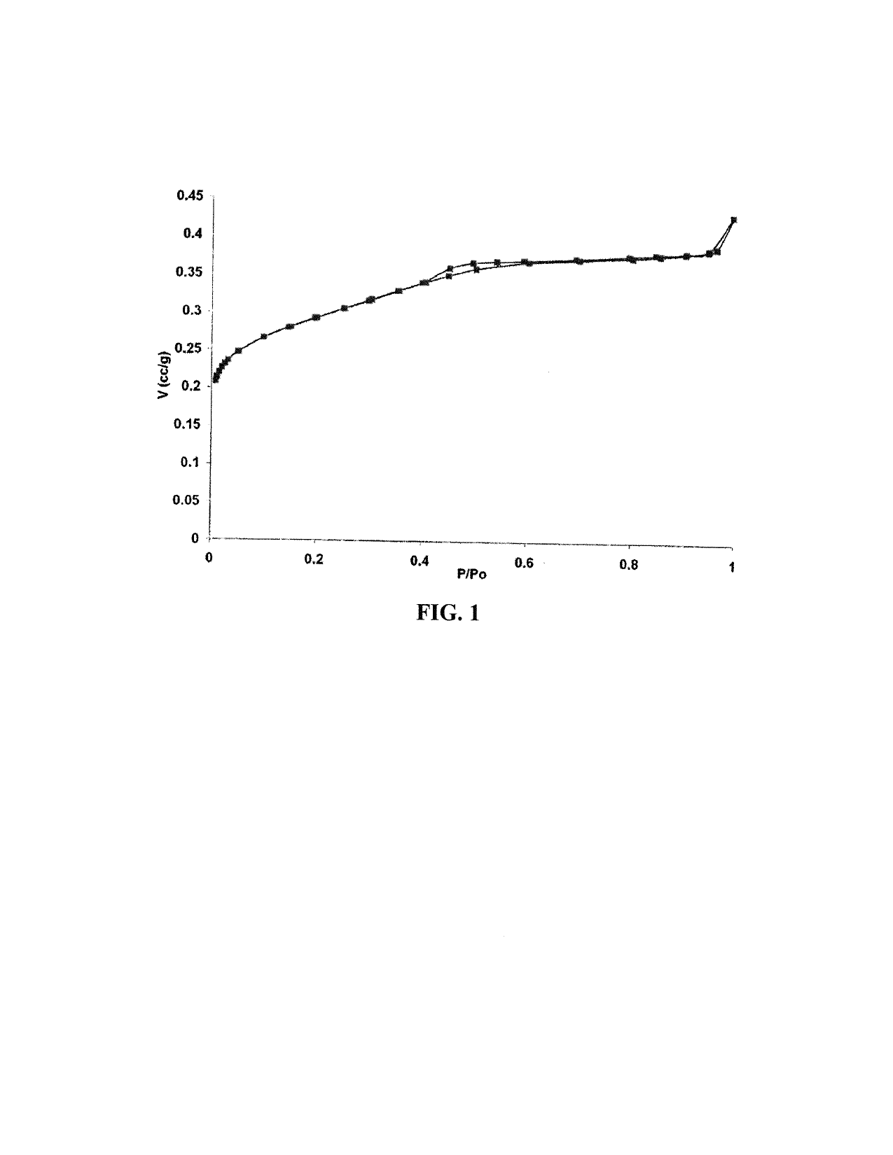

FIG. 1 shows the N₂ isotherm at 77K of the sample prepared as described above. As can be seen in FIG. 1, the sample exhibited a micropore volume of 0.16 cc/g and a mesopore volume of 0.19 cc/g.

### Example 2

### Introduction of Mesoporosity in 13X Zeolite with Non-Ionic Surfactant

In this example, 0.5 g of a non-ionic surfactant (Pluronic P-123™) was magnetically stirred in 30 mL of 2M HCl at 40° C. for 24 hours. Subsequently, 1 g of 13X type zeolite (Aldrich) was added and stirred into the mixture for 10 minutes. The resulting mixture was then aged at 100° C. for 48 hours. After cooling at room temperature, the solid product was filtered and thoroughly washed with water and then acetone. The product was then allowed to dry overnight. After drying, the solid product was subjected to shallow bed calcination so as to minimize its contact with water.

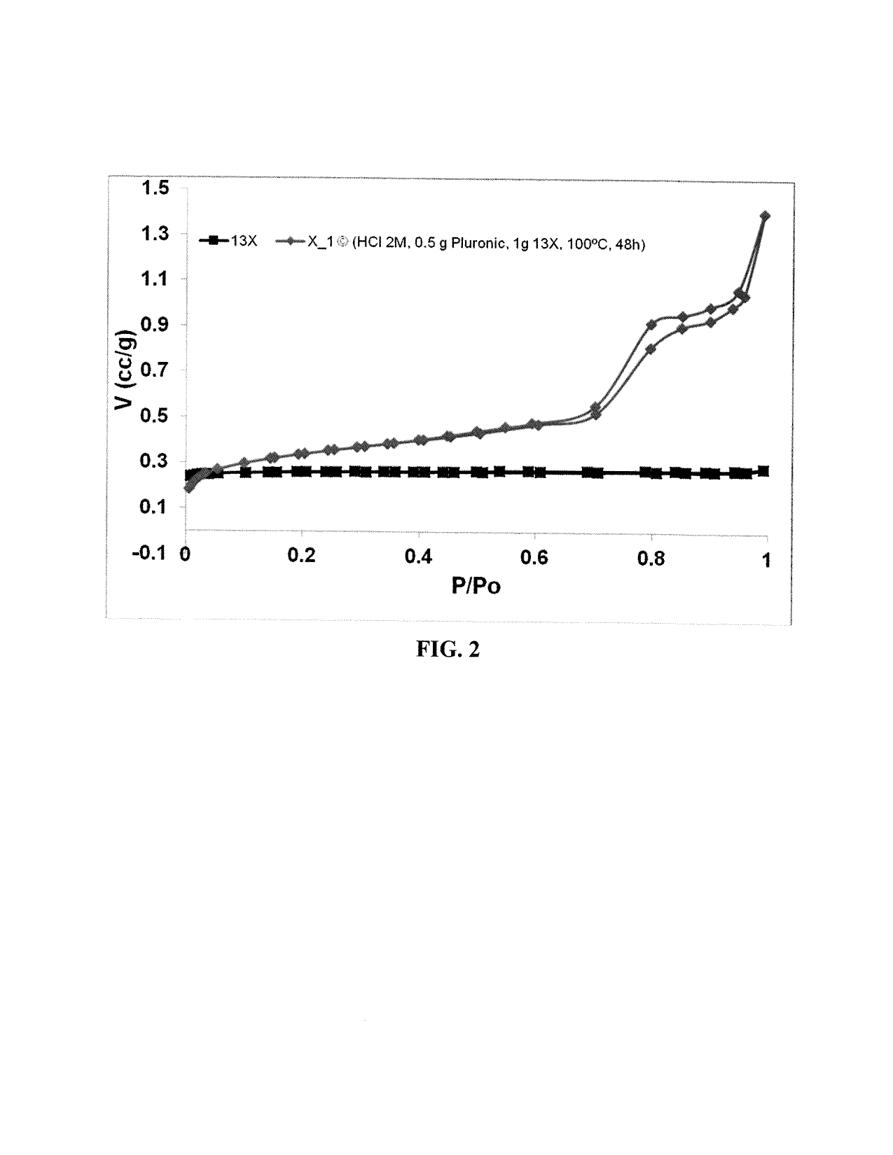

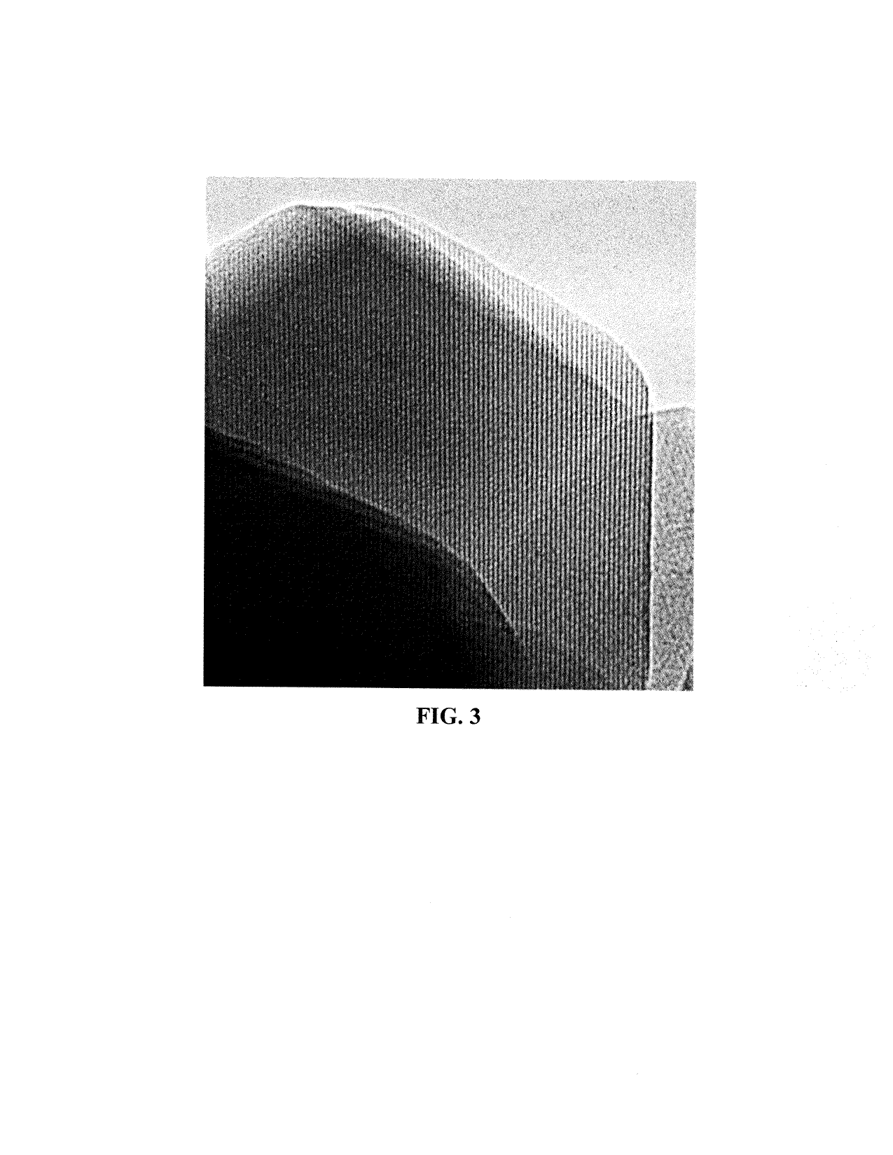

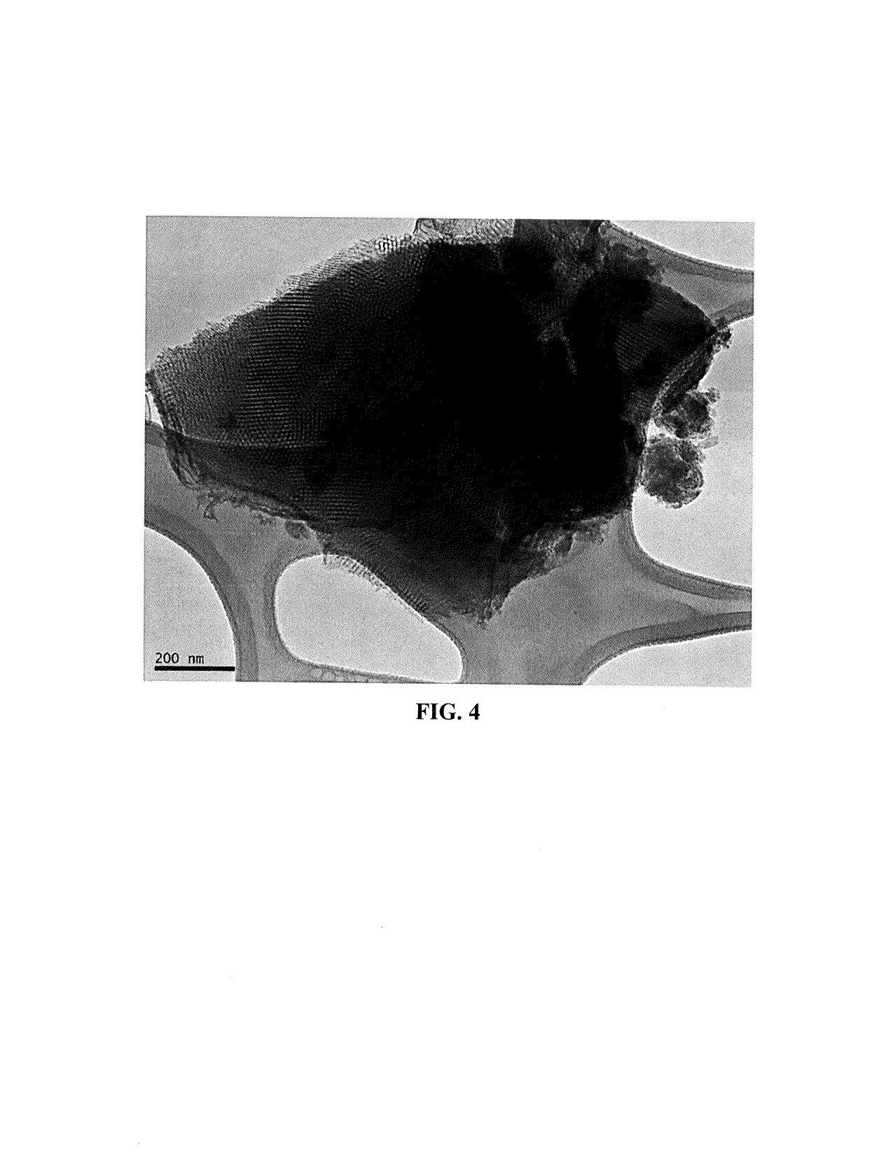

FIG. 2 shows the N₂ isotherms at 77K of the untreated X13 zeolite and the treated zeolite (“X-1”) prepared as described above. As can be seen in FIG. 2, the untreated X13 zeolite shows a type-I isotherm, which is characterized by adsorption at low relative pressures (P/Po), thus indicating the exclusive microporous nature of this untreated zeolite. In contrast, the isotherm of the treated sample (X-1) shows a combination of Type-I and Type-IV isotherms, which depicts significant adsorption at higher pressures (P/Po) and indicates the presence of both micropore volume (low relative pressures) and mesopore volume (higher relative pressures). This incorporation of mesoporosity can also be seen in micrographs of the untreated and treated zeolite. For example, FIG. 3 is a high magnification transmission electron microscopy (“TEM”) micrograph of the X13 zeolite before treatment. As shown in FIG. 3, no mesoporosity can be observed in the untreated zeolite. This lack of mesoporosity is indicated by the absence of large pores and the uninterrupted parallel lines in the crystal lattice of the zeolite. In contrast, FIG. 4 shows that the treated sample (X-1) contained a high amount of mesoporosity, which is indicated by the pale spots found throughout the crystal lattice of the zeolite.

### Example 3

### Introduction of Mesoporosity in 13X Zeolite with Non-Ionic Surfactant

In this example, 0.2 g (“X-5”) and 1.0 g (“X-7”) of a non-ionic surfactant (Pluronic P-123™) were separately added and magnetically stirred in separate solutions of 30 mL of 2M HCl at room temperature for 30 to 45 minutes and then at 40° C. for 2 hours. Subsequently, 0.36 g and 1.8 g of 13X type zeolite (Aldrich) were added and stirred into the X-5 and X-7 samples, respectively, at 40° C. for 20 hours. The resulting mixtures were then aged at 100° C. for 48 hours. After cooling at room temperature, the solid products were filtered and thoroughly washed with water and then acetone. The products were then allowed to dry overnight. After drying, the solid products were subjected to shallow bed calcination so as to minimize their contact with water.

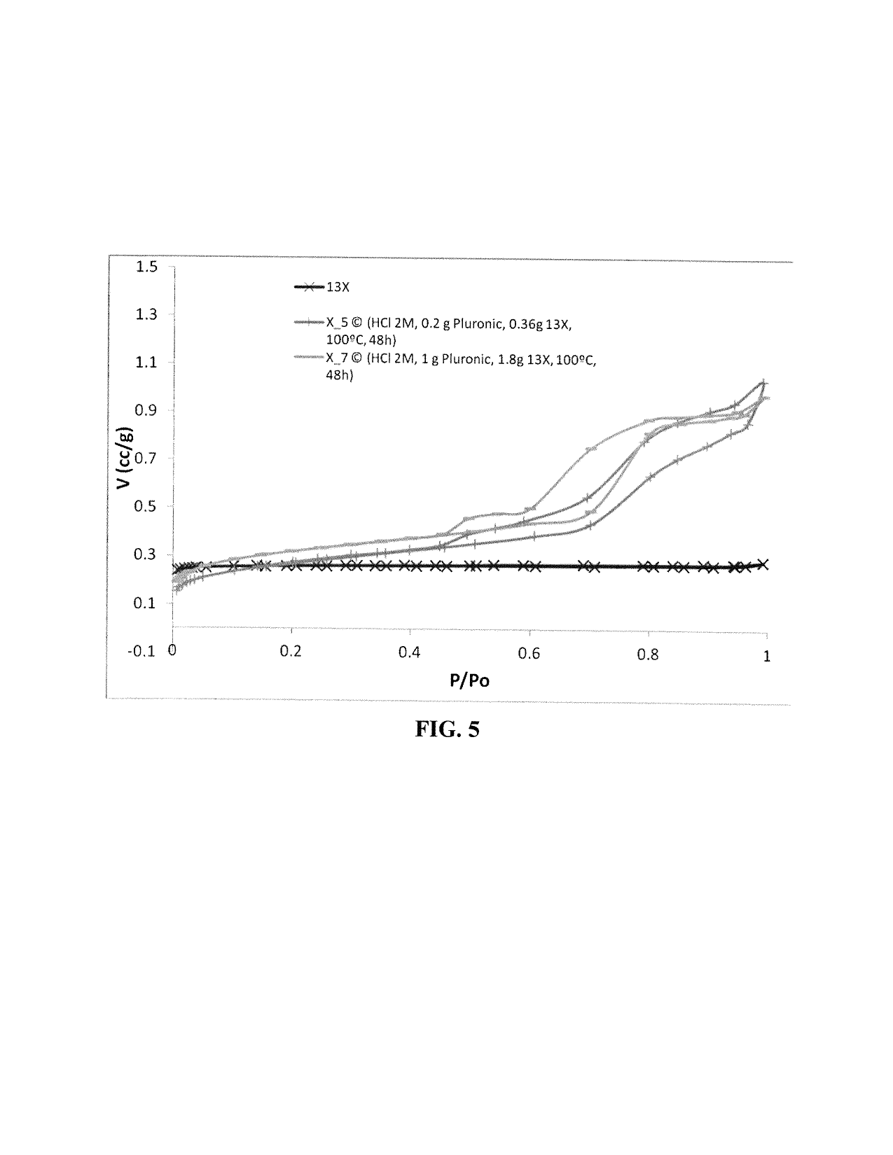

FIG. 5 shows the N₂ isotherms at 77K of the untreated X13 zeolite and the treated zeolite samples (X-5 and X-7) described above. As can be seen in FIG. 5, the untreated X13 zeolite shows a type-I isotherm, which is characterized by adsorption at low relative pressures (P/Po), thus indicating the exclusive microporous nature of this untreated zeolite. In contrast, the isotherms of the treated samples (X-5 and X-7) both show a combination of Type-I and Type-IV isotherms, which depict significant adsorption at higher pressures (P/Po) and indicates the presence of both micropore volume (low relative pressures) and mesopore volume (higher relative pressures). Thus, FIG. 5 shows that the treatment produced an increase in total pore volume and that both micropore and mesopore volumes can be adjusted using different conditions.

### Example 4

### Introduction of Mesoporosity in 13X Zeolite with Non-Ionic Surfactant

In this example, 1.0 g of a non-ionic surfactant (Pluronic P-123™) was magnetically stirred in 30 mL of 3M HCl at room temperature for 30 minutes and then at 40° C. for 2 hours. Subsequently, 1.8 g of 13X type zeolite (Aldrich) was added and stirred into the mixture at 40° C. for 20 hours. The resulting mixture was then aged at 100° C. for 48 hours. After cooling at room temperature, the solid product was filtered and thoroughly washed with water and then acetone. The product was then allowed to dry overnight. After drying, the solid product was subjected to shallow bed calcination so as to minimize its contact with water.

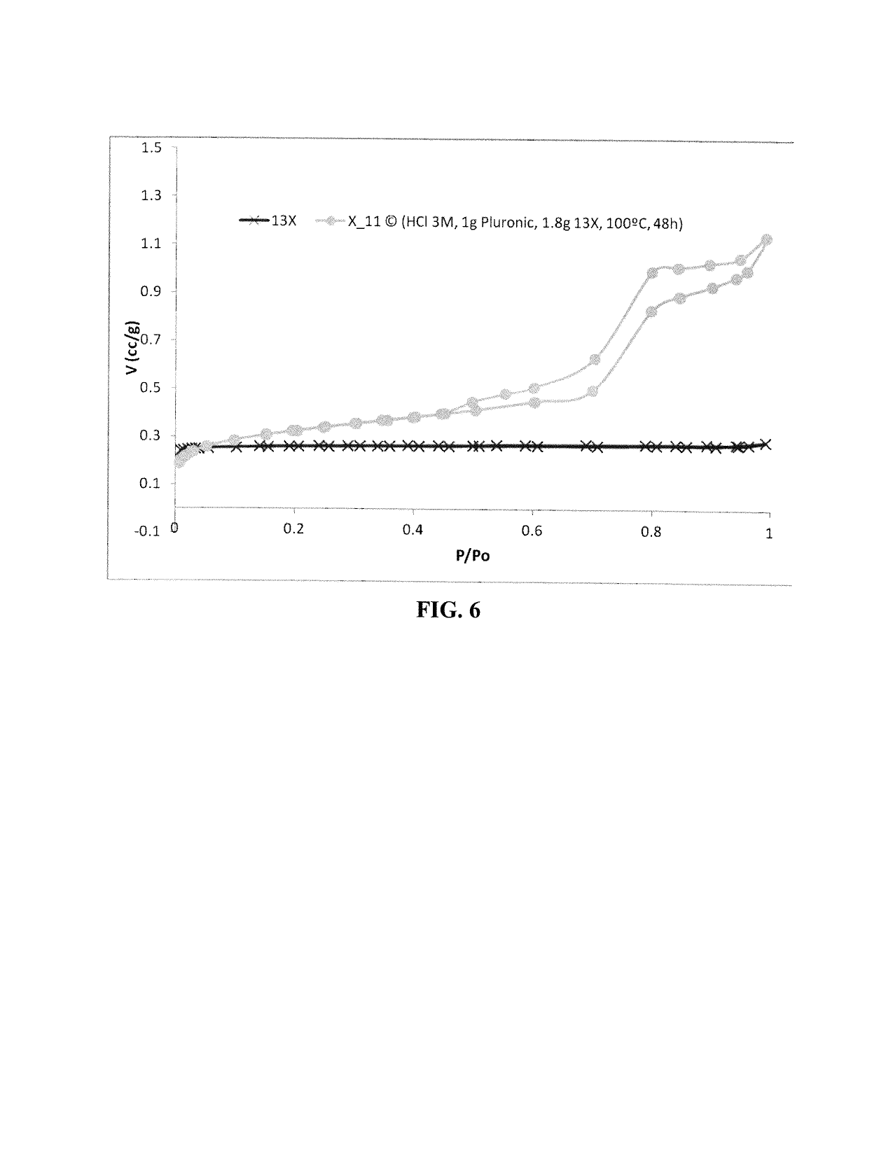

FIG. 6 shows the N₂ isotherms at 77K of the untreated X13 zeolite and the treated zeolite (“X-11”) prepared as described above. As can be seen in FIG. 6, the untreated X13 zeolite shows a type-I isotherm, which is characterized by adsorption at low relative pressures (P/Po), thus indicating the exclusive microporous nature of this untreated zeolite. In contrast, the isotherm of the treated sample (X-11) shows a combination of Type-I and Type-IV isotherms, which depicts significant adsorption at higher pressures (P/Po) and indicates the presence of both micropore volume (low relative pressures) and mesopore volume (higher relative pressures).

### Example 5

### Introduction of Mesoporosity in 4A Zeolite with Non-Ionic Surfactant

In this example, 0.5 g (“4A-1”) and 1.0 g (“4A-2”) of a non-ionic surfactant (Pluronic P-123™) were magnetically stirred in 30 mL of 2M HCl at 40° C. for 24 hours. Subsequently, 1 g and 2 g of 4A type zeolite (Aldrich) were added to samples 4A-1 and 4A-2, respectively, and stirred into the mixtures. The resulting mixtures were then aged at 100° C. for 48 hours. After cooling at room temperature, the solid products were filtered and thoroughly washed with water and then acetone. The products were then allowed to dry overnight. After drying, the solid products were subjected to shallow bed calcination so as to minimize their contact with water.

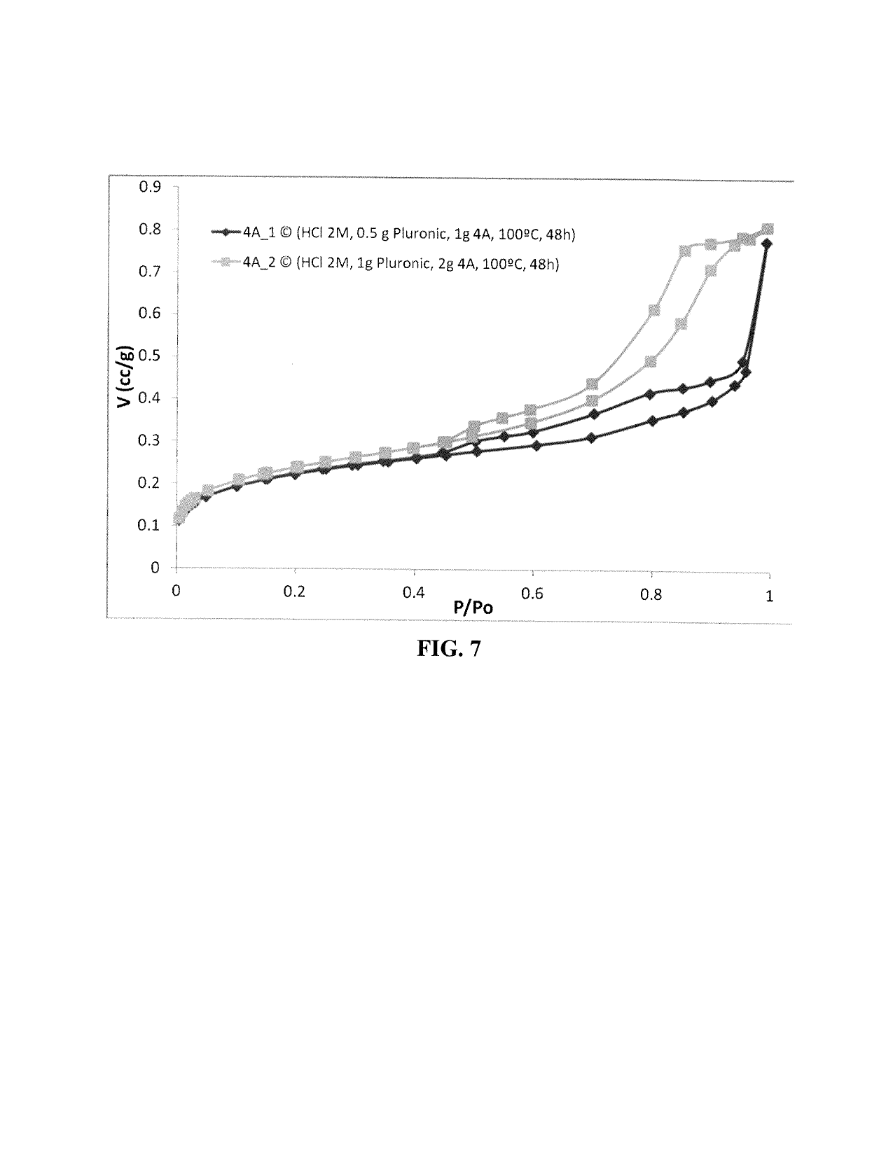

FIG. 7 shows the N₂ isotherms at 77K of the treated zeolite samples (4A-1 and 4A-2) described above. As can be seen in FIG. 7, the isotherms of the treated samples show that these samples exhibited strong adsorption properties at higher relative pressures, which indicates that these samples contained a large total pore volume and mesopore volume.

### SELECTED DEFINITIONS

It should be understood that the following is not intended to be an exclusive list of defined terms. Other definitions may be provided in the foregoing description accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise” provided above.

As used herein, the terms “having,” “has,” and “have” have the same open-ended meaning as “comprising,” “comprises,” and “comprise” provided above.

As used herein, the terms, “including,” “include,” and “included” have the same open-ended meaning as “comprising,” “comprises,” and “comprise” provided above.

Unless otherwise indicated, the term “mesoporous” is art-recognized and refers to a porous material comprising pores with an intermediate size, ranging anywhere from about 2 to about 50 nanometers.

The term “mesostructure” is art-recognized and refers to a structure comprising mesopores which control the architecture of the material at the mesoscopic or nanometer scale, including ordered and non-ordered mesostructured materials, as well as nanostructured materials, i.e., materials in which at least one of their dimensions is in the nanometer size range, such as nanotubes, nanorings, nanorods, nanowires, nanoslabs, and the like.

The term “zeolite” is defined as in the International Zeolite Association Constitution (Section 1.3) to include both natural and synthetic zeolites as well as molecular sieves and other microporous and mesoporous materials having related properties and/or structures. The term “zeolite” also refers to a group, or any member of a group, of structured aluminosilicate minerals comprising cations such as sodium and calcium or, less commonly, barium, beryllium, lithium, potassium, magnesium, and strontium; characterized by the ratio (Al+Si):O=approximately 1:2, an open tetrahedral framework structure capable of ion exchange, and loosely held water molecules that allow reversible dehydration. The term “zeolite” also includes “zeolite-related materials” or “zeotypes” which are prepared by replacing Si⁴⁺ or Al³⁺ with other elements as in the case of aluminophosphates (e.g., MeAPO, SAPO, ElAPO, MeAPSO, and ElAPSO), gallophosphates, zincophophates, and titanosilicates.

What is claimed is:

1. A method of forming a material comprising a mesoporous inorganic material having long-range crystallinity, said method comprising:
contacting an initial inorganic material having long-range crystallinity with a non-ionic surfactant thereby forming said mesoporous inorganic material having long-range crystallinity,
wherein said mesoporous inorganic material having long-range crystallinity has a total 20 to 135 Å diameter mesopore volume of at least 0.05 cc/g,
wherein said mesoporous inorganic material having long-range crystallinity has a crystalline content of at least 20 weight percent as measured by X-ray diffraction (“XRD”).

2. The method of claim 1, wherein said mesoporous inorganic material having long-range crystallinity has a total 20 to 135 Å diameter mesopore volume of at least 0.1 cc/g.

3. The method of claim 1, wherein said mesoporous inorganic material having long-range crystallinity has a crystalline content of at least at least 40 weight percent as measured by XRD.

4. The method of claim 1, wherein said mesoporous inorganic material having long-range crystallinity has a total 0 to 20 Å diameter micropore volume in the range of from about 0 to about 0.40 cc/g.

5. The method of claim 1, wherein said mesoporous inorganic material having long-range crystallinity has a total 20 to 135 Å diameter mesopore volume that is at least 50 percent greater than the 20 to 135 Å diameter mesopore volume of said initial inorganic material having long-range crystallinity.

6. The method of claim 1, wherein said mesoporous inorganic material having long-range crystallinity has a total 20 to 135 Å diameter mesopore volume that is at least 0.02 cc/g greater than the 20 to 135 Å diameter mesopore volume of said initial inorganic material having long-range crystallinity.

7. The method of claim 1, wherein said initial inorganic material having long-range crystallinity is a zeolite.

8. The method of claim 7, wherein said zeolite comprises a zeolite Y selected from the group consisting of USY, NH₄Y, NaY, a rare earth ion zeolite Y, or mixtures thereof.

9. The method of claim 1, wherein said mesoporous inorganic material having long-range crystallinity is a mesostructured zeolite.

10. The method of claim 1, wherein said contacting with said non-ionic surfactant is performed in a reaction medium further comprising an acid.

11. The method of claim 10, wherein said acid is selected from the group consisting of hydrochloric acid, sulfuric acid, nitric acid, acetic acid, sulfonic acid, oxalic acid, citric acid, ethylenediaminetetraacetic acid, tartaric acid, malic acid, glutaric acid, succinic acid, and mixtures of two or more thereof.

12. The method of claim 10, wherein said acid is present in an initial amount in the range of from about 2 to about 8 milliequivalents per gram of said initial inorganic material having long-range crystallinity.

13. The method of claim 1, further comprising contacting said mesoporous inorganic material having long-range crystallinity with a base, wherein said base is present in a ratio with the initial quantity of said initial inorganic material in the range of from about 0.1 to 5 mmol per gram of said initial inorganic material.

14. The method of claim 13, wherein said base is selected from the group consisting of NaOH, NH₄OH, KOH, Na₂CO₃, TMAOH, and mixtures of two or more thereof.

15. The method of claim 1, further comprising extracting at least a portion of said non-ionic surfactant from said mesoporous inorganic material having long-range crystallinity.

16. The method of claim 15, further comprising contacting a second inorganic material having long-range crystallinity with said extracted non-ionic surfactant thereby forming additional mesoporous inorganic material having long-range crystallinity.

17. A method of forming a material comprising a mesoporous zeolite, said method comprising:
contacting an initial zeolite with a non-ionic surfactant and a pH controlled medium thereby forming said mesoporous zeolite,
wherein said mesoporous zeolite has a total 20 to 135 Å diameter mesopore volume of at least 0.05 cc/g,
wherein said pH controlled medium has a pH in the range of from about 2 and about 6.

18. The method of claim 17, wherein said mesoporous zeolite has a total 20 to 135 Å diameter mesopore volume of at least 0.1 cc/g.

19. The method of claim 17, wherein said mesoporous zeolite has a total 0 to 20 Å diameter micropore volume in the range of from about 0 to about 0.40 cc/g.

20. The method of claim 17, wherein said mesoporous zeolite has a crystalline content of at least 25 weight percent as measured by X-ray diffraction (“XRD”).

21. The method of claim 17, wherein said mesoporous zeolite has a total 20 to 135 Å diameter mesopore volume that is at least 0.04 cc/g greater than the 20 to 135 Å diameter mesopore volume of said initial zeolite.

22. The method of claim 17, wherein said mesoporous zeolite is a mesostructured zeolite.

23. The method of claim 17, wherein said initial zeolite comprises a zeolite Y selected from the group consisting of USY, NH₄Y, NaY, a rare earth ion zeolite Y, or mixtures thereof.

24. The method of claim 17, wherein said pH controlled medium comprises an acid.

25. The method of claim 24, wherein said acid is selected from the group consisting of hydrochloric acid, sulfuric acid, nitric acid, acetic acid, sulfonic acid, oxalic acid, citric acid, ethylenediaminetetraacetic acid, tartaric acid, malic acid, glutaric acid, succinic acid, and mixtures of two or more thereof.

26. The method of claim 24, wherein said acid is present in an initial amount in the range of from about 2 to about 8 milliequivalents per gram of said initial zeolite.

27. The method of claim 24, wherein said pH controlled medium is formed by initially combining at least a portion of said non-ionic surfactant with said initial zeolite to form an initial mixture, and thereafter adding at least a portion of said acid to said initial mixture.

28. The method of claim 17, further comprising contacting said mesoporous zeolite with a base.

29. The method of claim 28, wherein said contacting with said base is performed at a temperature in the range of from about 30 to about 200° C.; wherein said base is present in a ratio with the initial quantity of said initial zeolite in the range of from about 0.1 to 5 mmol per gram of said initial zeolite.

30. The method of claim 17, further comprising extracting at least a portion of said non-ionic surfactant from said mesoporous zeolite and contacting a second zeolite with at least a portion of said extracted non-ionic surfactant to thereby form additional mesoporous zeolite.

31. The method of claim 17, wherein said contacting with said non-ionic surfactant is performed in the substantial absence of a base or hydrofluoric acid.

32. The method of claim 17, wherein said material comprises a composite material, wherein said composite material comprises at least one binder.
